(19) United States
(12) Patent Application Publication
(10) Pub. No.: US 2013/0163781 A1
(43) Pub. Date: Jun. 27, 2013

(54) BREATHING NOISE SUPPRESSION FOR AUDIO SIGNALS

(71) Applicants: Jes Thyssen, San Juan Capistrano, CA (US); Elias Nemer, Irvine, CA (US)

(72) Inventors: Jes Thyssen, San Juan Capistrano, CA (US); Elias Nemer, Irvine, CA (US)

(73) Assignee: BROADCOM CORPORATION, Irvine, CA (US)

(21) Appl. No.: 13/335,221

(22) Filed: Dec. 22, 2011

(51) Int. Cl. H04B 15/00

(52) U.S. Cl. 381/94.3; 381/94.1

(57) ABSTRACT

Systems and methods are described herein for detecting and suppressing breathing noise in an audio signal. First, systems and methods are described that analyze audio signals generated by two or more microphones to detect breathing noise in one of the audio signals and that leverage the multiple microphones to suppress detected breathing noise in a manner that minimizes signal distortion. Then, systems and methods are described that are capable of analyzing the audio signal generated by a single microphone to detect breathing noise in the audio signal and thereafter suppress it.

### FIELD OF TECHNOLOGY

The present invention generally relates to systems and methods for improving the perceptual quality of audio signals, including but not limited to audio signals transmitted between telephony devices in a telephony system.

### BACKGROUND

During a telephone call, a participant in the call may not be speaking but his mouth may nevertheless be positioned near a microphone of the telephony device that he is using to participate in the call. In further accordance with such a scenario, such participant may breathe on the microphone. The physical interaction of the participant's breath and the microphone can give rise to a non-acoustic noise that will be referred to herein as “breathing noise.” Such breathing noise may be captured as part of an audio signal generated by the microphone and then transmitted to the telephony device(s) being used by the other participant(s) in the call, which will make the breathing noise audible. To the other participant(s), such breathing noise can be extremely distracting and annoying.

For example, in a conference call scenario involving many participants, it is often the case that some of the participants will not be speaking for long periods of time. If one of these non-speaking participants is breathing into the microphone of his telephony device, then everyone else on the conference call will be forced to listen to any resultant breathing noise, which can be distracting and bothersome. In such a scenario, it may not be possible to determine which participant is the source of the breathing noise. Furthermore, even if it could be determined which participant is the source of the breathing noise, it is typically not possible to selectively mute that participant from a remote terminal. Additionally, it may be deemed impolite or otherwise undesirable to point out to a participant that he is creating such breathing noise.

Certain telephony devices are designed such that the microphone into which a user speaks will be positioned very near the user's mouth during normal usage thereof. For example, many desktop telephones include handsets having mouthpieces that will be situated directly in front of a user's mouth when the user is using the handset in a normal manner. Additionally, many headsets used for telephony include stems that enable a user to situate the headset microphone very close to the user's mouth. Since such telephony devices enable the microphone to be positioned very close to the mouth of the user, such telephony devices may be particularly prone to a breathing noise problem. However, the problem is by no means limited to such telephony devices and breathing noise can be generated by any of a wide variety of telephony devices.

Due to the fact that breathing noise is non-stationary in nature, it cannot be suppressed using conventional noise reduction algorithms that are designed to attenuate stationary noise, such as relatively constant or slowly-changing background noise. What is needed, then, is a technique for effectively detecting and attenuating or eliminating breathing noise present in an audio signal, such as in an audio signal generated by a microphone of a telephony device.

### BRIEF DESCRIPTION OF THE DRAWINGS/FIGURES

The accompanying drawings, which are incorporated herein and form part of the specification, illustrate the present invention and, together with the description, further serve to explain the principles of the invention and to enable a person skilled in the relevant art(s) to make and use the invention.

FIG. 1 is a block diagram of an example telephony device that implements a multi-microphone breathing noise suppression technique in accordance with an embodiment.

FIGS. 2A and 2B present a front and back perspective view, respectively, of an example handset of that may be used to implement the telephony device of FIG. 1.

FIG. 3 is a top perspective view of a telephony device which represents another possible implementation of the telephony device of FIG. 1.

FIG. 4 presents a perspective view of an example headset that may be used to implement the telephony device of FIG. 1.

FIG. 5 depicts a flowchart of a multi-microphone method for suppressing breathing noise in an audio signal in accordance with an embodiment.

FIG. 6 depicts a series of graphs that show the energy of an audio signal that includes breathing noise as a function of frequency.

FIG. 7 depicts a flowchart of a multi-microphone method for suppressing breathing noise in accordance with an embodiment.

FIG. 8 depicts a flowchart of a method for identifying frequency sub-bands in which breathing noise is present in an audio signal in accordance with an embodiment.

FIG. 9 is a block diagram of an example telephony device that implements a single microphone breathing noise suppression technique in accordance with an embodiment.

FIG. 10 depicts a flowchart of a single microphone method for suppressing breathing noise in an audio signal in accordance with an embodiment.

FIG. 11 is a block diagram of a system that adaptively constructs a notch filter that can be applied to suppress breathing noise in an audio signal.

FIG. 12 is a block diagram of a processor-based system that may be used to implement various embodiments.

The features and advantages of the present invention will become more apparent from the detailed description set forth below when taken in conjunction with the drawings, in which like reference characters identify corresponding elements throughout. In the drawings, like reference numbers generally indicate identical, functionally similar, and/or structurally similar elements. The drawing in which an element first appears is indicated by the leftmost digit(s) in the corresponding reference number.

### DETAILED DESCRIPTION

### A. Introduction

The following detailed description refers to the accompanying drawings that illustrate exemplary embodiments of the present invention. However, the scope of the present invention is not limited to these embodiments, but is instead defined by the appended claims. Thus, embodiments beyond those shown in the accompanying drawings, such as modified versions of the illustrated embodiments, may nevertheless be encompassed by the present invention.

References in the specification to “one embodiment,” “an embodiment,” “an example embodiment,” or the like, indicate that the embodiment described may include a particular feature, structure, or characteristic, but every embodiment may not necessarily include the particular feature, structure, or characteristic. Moreover, such phrases are not necessarily referring to the same embodiment. Furthermore, when a particular feature, structure, or characteristic is described in connection with an embodiment, it is submitted that it is within the knowledge of one skilled in the art to implement such feature, structure, or characteristic in connection with other embodiments whether or not explicitly described.

Various systems and methods are described herein for detecting and suppressing breathing noise in an audio signal. In particular, in Section B, systems and methods are described that analyze audio signals generated by two or more microphones to detect breathing noise in one of the audio signals. Such systems and methods may also leverage the multiple microphones to suppress detected breathing noise in a manner that minimizes signal distortion. In Section C, systems and methods are described that are capable of analyzing the audio signal generated by a single microphone to detect breathing noise in the audio signal and thereafter suppress it. Section D describes a processor-based system that may be used to implement various features of these systems and methods. Section E provides some concluding comments.

The systems and methods described herein may advantageously be used to improve the perceptual quality of audio signals transmitted between telephony devices in a telephony system. Accordingly, various embodiments described herein are implemented as logic operating within a telephony device. However, it is important to note that the systems and methods described herein may broadly be applied to any audio signal that may include breathing noise, including recorded audio signals (e.g., audio signals stored in files) as well as audio signals transmitted between computers or other devices that are not traditionally considered telephony devices.

### B. Example Multi-Microphone Breathing Noise Suppression Systems and Methods

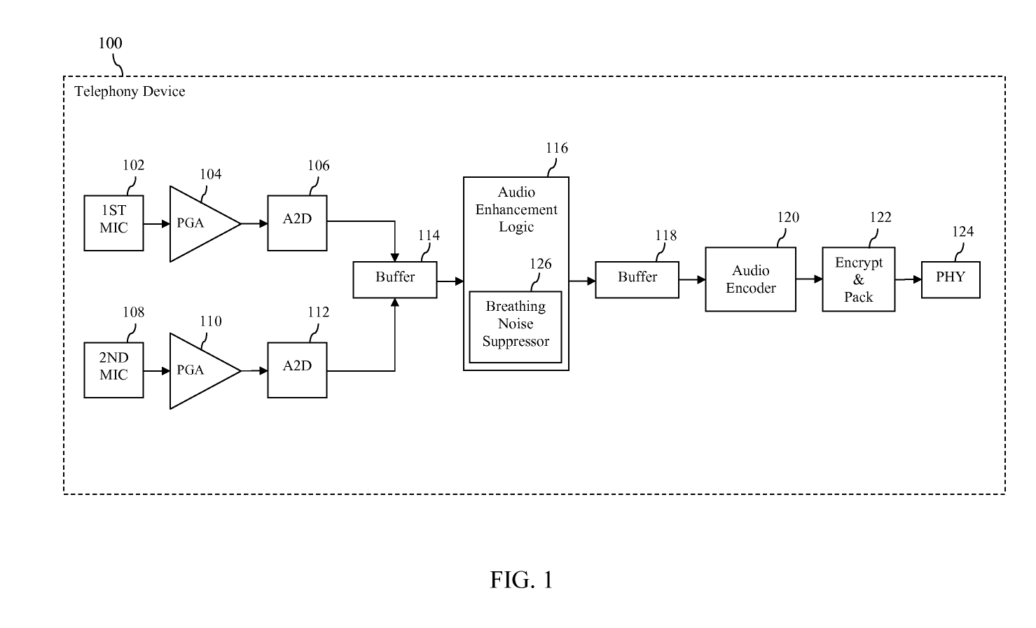

FIG. 1 is a block diagram of an example telephony device 100 that implements a multi-microphone breathing noise suppression technique in accordance with an embodiment. Telephony device 100 is intended to broadly represent any type of telephony device that is capable of receiving at least two input audio signals via at least two corresponding microphones and to use such input audio signals to generate an output audio signal for transmission to at least one remote telephony device. The elements of example audio terminal 100 will now be described in more detail.

As shown in FIG. 1, audio terminal 100 includes a first microphone 102. First microphone 102 is an acoustic-to-electric transducer that operates in a well-known manner to convert sound waves, such as sound waves associated with a user's speech and/or acoustic noise, into a first analog audio signal. A first programmable gain amplifier (PGA) 104 is connected to first microphone 102 and is configured to amplify the first analog audio signal produced by microphone 102 to generate a first amplified analog audio signal. A first analog-to-digital (A2D) converter 106 is connected to first PGA 104 and is adapted to convert the first amplified analog audio signal produced by first PGA 104 into a first digital audio signal. The first digital audio signal produced by first A2D converter 106, or at least a portion thereof, may be temporarily stored in a buffer 114 pending processing by audio enhancement logic 116.

Audio terminal 100 also includes a second microphone 108. Second microphone 108 operates in a like manner to first microphone 102 to convert sound waves into a second analog audio signal. A second PGA 110 is connected to second microphone 108 and is configured to amplify the second analog audio signal produced by second microphone 108 to generate a second amplified analog audio signal. A second A2D converter 112 is connected to second PGA 110 and is adapted to convert the second amplified analog audio signal produced by second PGA 110 into a second digital audio signal. The second digital audio signal produced by second A2D converter 112, or at least a portion thereof, may be temporarily stored in buffer 114 pending processing by speech enhancement logic 110. It is noted that separate buffers may also be used to store the first and second digital audio signals, or portions thereof, pending processing thereof by audio enhancement logic 116.

Audio enhancement logic 116 is configured to process the first and second digital audio signals to produce an output digital audio signal. Such output digital audio signal, or at least a portion thereof, may be temporarily stored in a buffer 118 pending processing by an audio encoder 120. Audio enhancement logic 116 may be configured to perform operations that tend to improve the perceptual quality and intelligibility of any speech content included in the output digital audio signal. For example, audio enhancement logic 116 may include a noise suppressor and/or an echo canceller that may operate to improve the perceptual quality and intelligibility of any speech content included in the output digital audio signal.

As further shown in FIG. 1, audio enhancement logic 116 also includes a breathing noise suppressor 126. As will be discussed in more detail herein, breathing noise suppressor 126 operates to determine when breathing noise is present in the first digital audio signal that originated from first microphone 102 by at least jointly analyzing the first digital audio signal and the second digital audio that originated from second microphone 108. Furthermore, when breathing noise suppressor 126 determines that breathing noise is present in the first digital audio signal, it modifies the first digital audio signal to suppress the breathing noise therein. As will be discussed below, such modification may include but is not limited to replacing all or part of the first digital audio signal with a substitute audio signal or muting the first digital audio signal. Other types of modification will also be described. The potentially-modified first digital audio signal may then be used to produce the digital output audio signal. Alternatively, the potentially-modified first digital audio signal may be further processed to produce the digital output audio signal.

Audio encoder 120 is connected to buffer 118. Audio encoder 120 is configured to receive the output digital audio signal and to compress the output digital audio signal in accordance with a particular encoding technique. Encryption and packing logic 122 is connected to audio encoder 120 and is configured to encrypt and pack the encoded audio signal produced by audio encoder 120 into packets. The packets produced by encryption and packing logic 122 are provided to a physical layer (PHY) interface 124 for subsequent transmission to a remote telephony device over a suitable communication link.

In certain embodiments, first microphone 102 is situated such that it will be closer to a mouth of a user of telephony device 100 than second microphone 108 during normal usage of telephony device 100—in other words, when telephony device 100 is being used as intended or when telephony device 100 is being used in a manner adopted by most users of such devices. For example, first microphone 102 may be situated such that a user will be speaking directly or nearly directly into first microphone 102 during normal usage of telephony device 100, while second microphone 108 may be situated such that the user will not be speaking directly or nearly directly into second microphone 102 during normal usage of telephony device 100. In accordance with such a configuration, it is reasonable to expect that breathing noise may only appear in the audio signal generated by first microphone 102 but will never appear in the audio signal generated by second microphone 108 during normal usage of telephony device 100, since the generation of breathing noise requires physical interaction between the user's breath and a microphone. As will be explained below, breathing noise suppressor 126 can be configured to exploit this fact to help determine whether breathing noise is present in the audio signal generated by first microphone 102.

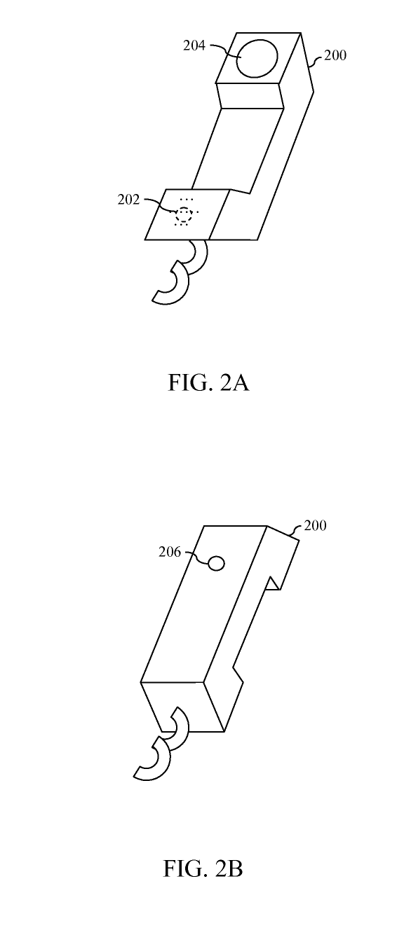

FIGS. 2A and 2B present a front and back perspective view, respectively, of an example handset 200 that may be used to implement telephony device 100. As shown in FIG. 2A, handset 200 includes a first microphone 202 and a speaker 204. First microphone 202 may represent, for example, first microphone 102 as described above in reference to FIG. 1. As shown in FIG. 2B, handset 200 also includes a second microphone 206, which may represent second microphone 108 as described above in reference to FIG. 1. During normal usage of handset 200, it is to be expected that a user's mouth will be closer to first microphone 202, which is located on the front of the handset, than to second microphone 206, which is located on the back of the handset. In fact, during normal usage of handset 200, it is reasonable to expect that a user will be speaking directly or nearly directly into first microphone 202 and that the user will not be speaking directly or nearly directly into second microphone 206.

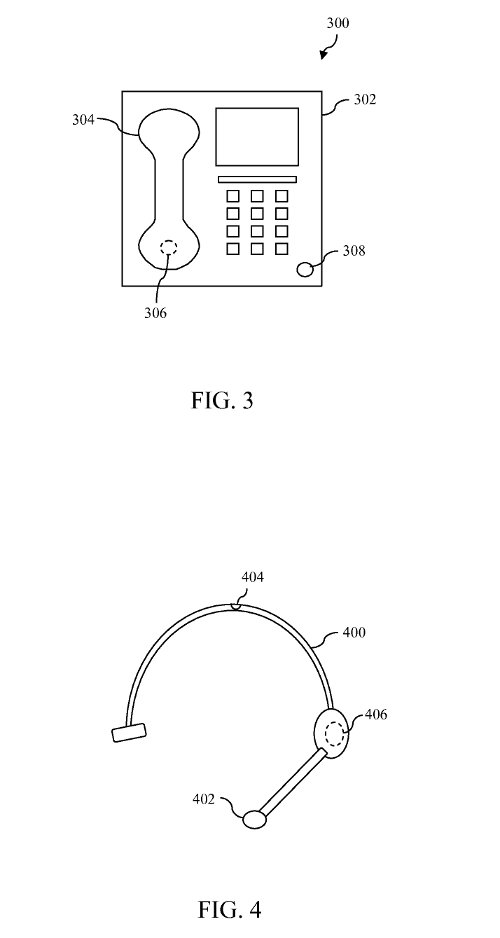

FIG. 3 is a top perspective view of a telephony device 300 that represents another possible implementation of telephony device 100 of FIG. 1. As shown in FIG. 3, telephony device 300 includes a base 302 and a handset 304. Handset 304 includes a first microphone 306 which may represent, for example, first microphone 102 as described above in reference to FIG. 1. As further shown in FIG. 3, base 302 includes a second microphone 308 which may represent, for example, second microphone 108 as described above in reference to FIG. 1. During normal usage of telephony device 300, it is to be expected that a user's mouth will be closer to first microphone 306, which is located on the front of handset 304, than to second microphone 308, which is located on base 302. In fact, during normal usage of telephony device 300, it is reasonable to expect that a user will be speaking directly or nearly directly into first microphone 306 and that the user will not be speaking directly or nearly directly into second microphone 308.

FIG. 4 is a perspective view of a headset 400 that may be used to implement telephony device 100 of FIG. 1. As shown in FIG. 4, headset 400 includes a first microphone 402 and a speaker 406. First microphone 402 may represent, for example, first microphone 102 as described above in reference to FIG. 1. As further shown in FIG. 4, headset 400 also includes a second microphone 404, which may represent second microphone 108 as described above in reference to FIG. 1. During normal usage of headset 400, it is to be expected that a user's mouth will be closer to first microphone 402, which is located at the end of a stem that extends around the face of the user, than to second microphone 404, which is located at the top of the headset. In fact, during normal usage of headset 400, it is reasonable to expect that a user will be speaking directly or nearly directly into first microphone 402 and that the user will not be speaking directly or nearly directly into second microphone 404.

The telephony device implementations shown in FIGS. 2A, 2B, 3 and 4 have been presented herein by way of example only and are not intended to be limiting. Persons skilled in the relevant art(s) will appreciate that other telephony devices that include two or more microphones may also be used to perform the multi-microphone breathing noise suppression techniques that will be described herein.

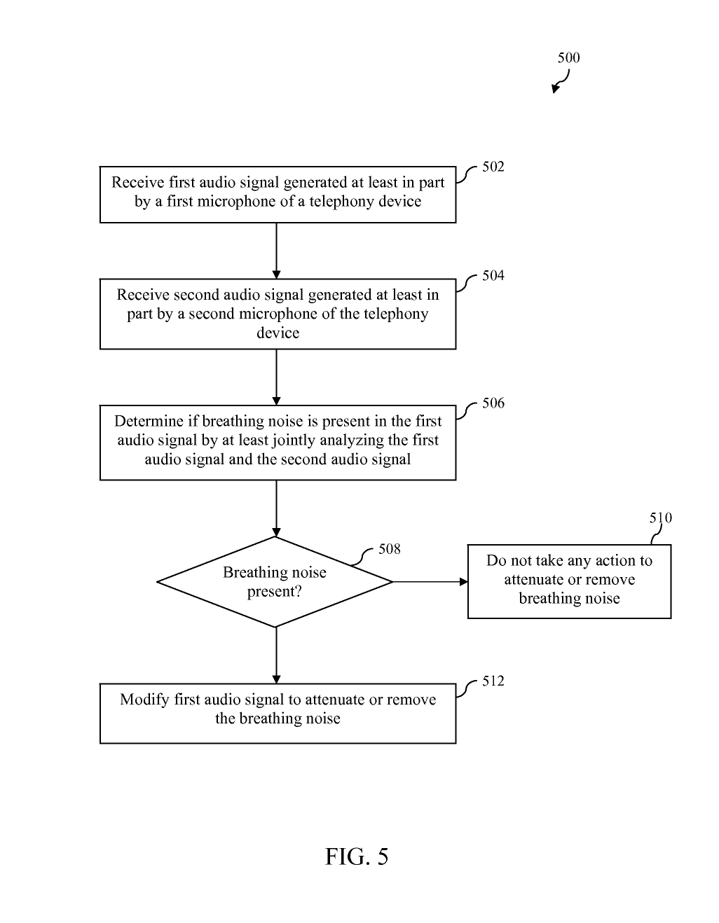

FIG. 5 depicts a flowchart 500 of a multi-microphone method for suppressing breathing noise in an audio signal in accordance with an embodiment. The method of flowchart 500 may be performed by breathing noise suppressor 126 of telephony device 100 as described above in reference to FIG. 1. However, the method is not limited to that implementation and may be performed by other components or devices.

As shown in FIG. 1, the method of flowchart 500 begins at step 502 in which a first audio signal generated at least in part by a first microphone of a telephony device is received. The first audio signal may comprise, for example, the first digital audio signal that is generated in part by first microphone 102 of telephony device 100 as described above in reference to FIG. 1.

At step 504, a second audio signal generated at least in part by a second microphone of the telephony device is received. The second audio signal may comprise, for example, the second digital audio signal that is generated in part by second microphone 108 of telephony device 100 as described above in reference to FIG. 1. It is to be understood that the received first and second audio signals referred to in steps 502 and 504 are time-aligned—that is to say, the first and audio signals represent audio content captured during the same time period.

At step 506, it is determined if breathing noise is present in the first audio signal by at least jointly analyzing the first audio signal and the second audio signal. This step may include, for example, calculating a measure of coherence between the first audio signal and the second audio signal and then determining that breathing noise is present in the first audio signal in response to at least determining that the measure of coherence is less than a predefined threshold.

Since in certain embodiments the first microphone is situated more closely to the mouth of a user of the telephony device than the second microphone, it is likely that if breathing noise occurs, such breathing noise will appear in the first audio signal only and not in the second audio signal. Thus, during a period of time in which the user is breathing into the first microphone and thereby generating breathing noise, it is likely that there will be a low level of coherence between the first audio signal and the second audio signal. In contrast, during periods of time in which the user is speaking and there is no breathing noise, it is likely that both the first and second microphone will capture the speech signal (although one microphone may capture a time delayed and/or scaled version of the speech signal as compared to the other or a filtered version in general), such that the degree of coherence between the first and second audio signals will be greater than during periods of breathing noise. Additionally, during periods of time in which the user is not speaking and there is no breathing noise, it is likely that both the first and second microphone will capture any acoustic background noise emanating from local noise sources (where the amount of time delay between captured signals may depend on the location of the noise sources relative to the two microphones), such that the degree of coherence between the first and second audio signals will be greater than during periods of breathing noise. Consequently, determining if a measure of coherence between the first and second audio signal is less than a predefined threshold can be an effective way of determining if there is breathing noise present in the first audio signal.

A measure of coherence between the first audio signal and the second audio signal may be calculated, for example, by estimating a cross-correlation between the first audio signal and the second audio signal in a time domain or estimating a cross-spectrum between the first audio signal and the second audio signal in the frequency domain.

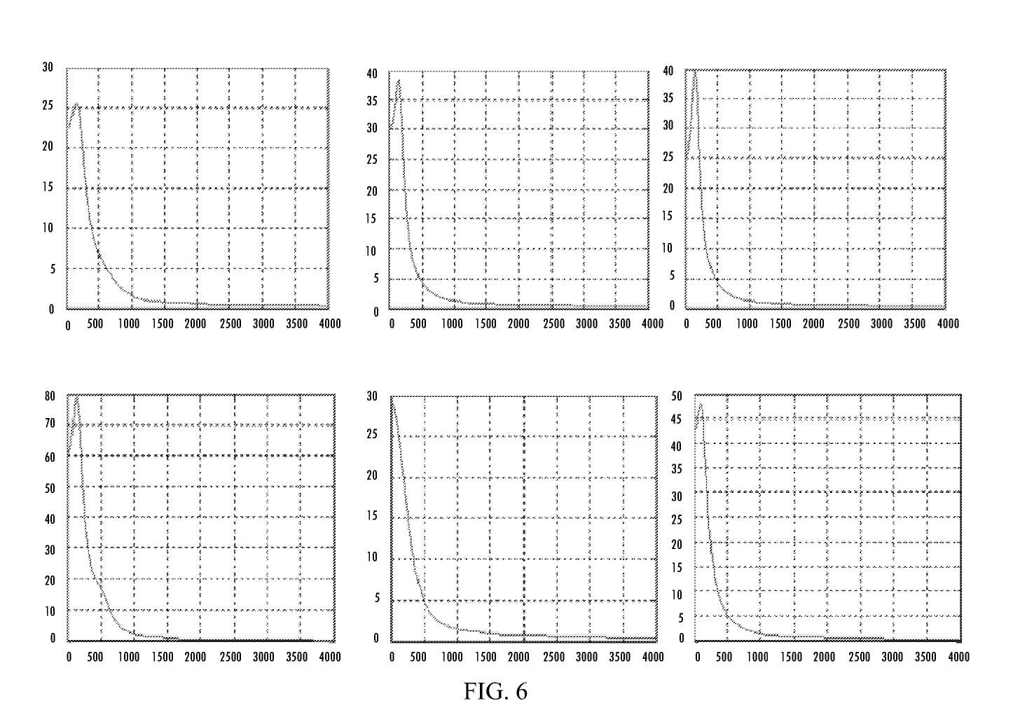

Estimating the cross-spectrum between the first audio signal and the second audio signal in the frequency domain may be deemed advantageous because it enables various observable characteristics of breathing noise to be exploited to perform the detection function. For example, it has been observed that when breathing noise is present in an audio signal, there is a large concentration of energy in the lower frequency portion of the signal spectrum. This is shown, for example, by the various graphs depicted in FIG. 6, each of which shows the energy of an audio signal that includes breathing noise as a function of frequency. As shown by each of the graphs, there is a large concentration of energy in the lower spectrum with little or no energy in the upper spectrum.

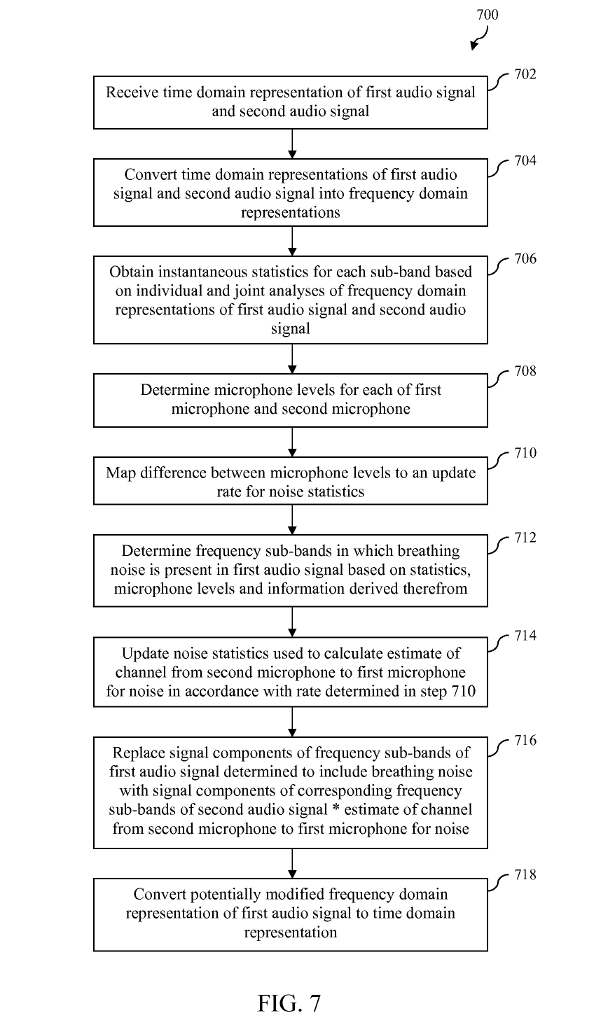

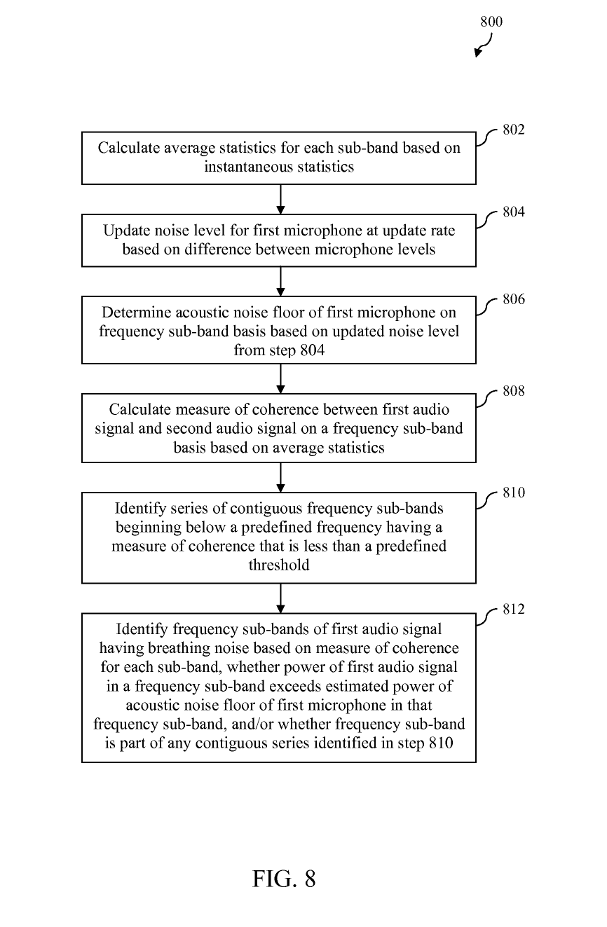

In view of these characteristics of breathing noise, when there is breathing noise present in the first audio signal but not in the second audio signal, it is to be expected that the lack of coherence between the first audio signal and the second audio signal will be prevalent in the lower frequencies. Moreover the energy in the lower frequencies will likely exceed an acoustic noise floor. An embodiment described below in reference to flowchart 700 of FIG. 7 and flowchart 800 of FIG. 8 makes use of these facts to detect breathing noise.

In particular, the embodiment described below in reference to flowchart 700 of FIG. 7 and flowchart 800 of FIG. 8 calculates a measure of coherence between a frequency domain representation of the first audio signal and a frequency domain representation of the second audio signal for each of a plurality of frequency sub-bands. The embodiment then determines that breathing noise is present in a particular frequency sub-band based on one or more of: (1) determining that the particular frequency sub-band has a measure of coherence that is less than a predefined threshold; and (2) determining that the particular frequency sub-band is one of a contiguous series of frequency sub-bands beginning below a predefined frequency, each of the contiguous series of frequency sub-bands having a measure of coherence that is less than the predefined threshold. The embodiment may further determine that breathing noise is present in the particular frequency sub-band based on determining that the power of the frequency domain representation of the first audio signal in the particular frequency sub-band exceeds an estimated power of a noise floor of the first audio signal in the particular frequency sub-band by at least a predefined amount.

In a further embodiment, calculating the measure of coherence between the first audio signal and the second audio signal may additionally comprise estimating a fourth-order cross-cumulant between the first audio signal and the second audio signal. An extension to the second-order cross-correlation discussed above, the fourth-order cross-cumulant between the first audio signal and the second audio signal can be used to discriminate between periods of voiced speech (i.e., a harmonic signal) and periods of all other types of signals (unvoiced speech, silence, or breathing noise). In accordance with such an embodiment, breathing noise can only be detected if the measure of coherence based on the fourth-order cross-cumulant is sufficiently low.

Details concerning how to estimate the fourth-order cross-cumulant between two audio signals are provided in commonly-owned, co-pending U.S. patent application Ser. No. 12/910,188 to Elias Nemer, entitled “Audio Spatialization for Conference Calls with Multiple and Moving Talkers” and filed Oct. 22, 2010, the entirety of which is incorporated by reference herein. As observed in that application, higher order statistics such as the fourth-order cross-cumulant first are more robust to the presence of Gaussian noise than the second-order counterparts. Thus, such higher order statistics can be used in conjunction with the second-order counterparts to provide an additional level of confidence in detecting the presence or non-presence of breathing noise.

Returning now to the description of flowchart 500 of FIG. 5, at decision step 508, the results of step 506 are analyzed to determine if breathing noise is present in the first audio signal. If it is determined that there is no breathing noise present in the first audio signal, then controls flow to step 510, in which no action is taken to suppress or remove breathing noise in the first audio signal. However, if it is determined that there is breathing noise present in the first audio signal, then control flows to step 512, in which the breathing noise present in the first audio signal is attenuated or removed.

The manner in which the breathing noise present in the first audio signal is attenuated or removed may vary depending upon the implementation. In accordance with one embodiment, the first audio signal may simply be muted. Since in many cases, breathing noise will be present only when a user of telephony device 100 is not speaking but is instead simply breathing into the first microphone, muting the first audio signal may be deemed an acceptable solution for suppressing the breathing noise.

In an alternate embodiment, a comfort noise generator may be used to generate an audio signal that simulates the background noise of the environment in which the user is located and this audio signal may be used to replace at least a portion of the first audio signal in order to remove the breathing noise. A variety of systems and methods for generating comfort noise are known in the art and may be used to perform this function.

In a further embodiment, the breathing noise may be removed by replacing at least a portion of the first audio signal with at least a corresponding portion of the second audio signal or with an audio signal that is derived from at least a corresponding portion of the second audio signal. For example, at least a portion of the first audio signal may simply be replaced with a corresponding portion of the second audio signal. Alternatively, the replacement audio signal may be obtained by multiplying at least a portion of the second audio signal by an estimate of a channel from the second microphone to the first microphone.

In an embodiment in which determining that breathing noise is present in the first audio signal comprises determining that breathing noise is present in particular frequency sub-bands of a frequency domain representation of the first audio signal (such as the embodiment to be described below in reference to flowchart 700 of FIG. 7 and flowchart 800 of FIG. 8), this step may comprise replacing signal components in the particular frequency sub-bands of the frequency domain representation of the first audio signal with signal components derived from corresponding frequency sub-bands of a frequency domain representation of the second audio signal. The replacement signal components may be obtained, for example, by calculating an estimate of a channel from the second microphone to the first microphone for noise for each of the particular frequency sub-bands and then multiplying the estimate of the channel for each of the particular frequency sub-bands by signal components in the corresponding frequency sub-bands of the frequency domain representation of the second audio signal.

In still further embodiments, the breathing noise may be attenuated by using specially designed filters (e.g., notch filters or high-pass filters). Various examples of suitable filters will be described in a subsequent section dealing with single-microphone breathing noise suppression algorithms.

In yet further embodiments, the breathing noise may be attenuated or removed by utilizing any of a variety of well-known acoustic beamforming techniques that may be implemented using multiple microphones. Such acoustic beamforming techniques may be used, for example, to place a null in the anticipated direction of the source of the breathing noise (i.e., the user's mouth) when breathing noise is detected, thereby removing or at least attenuating the breathing noise. Persons skilled in the relevant art(s) will appreciate that the effectiveness of such acoustic beamforming techniques may depend, at least in part, upon the number of microphones used, the location of such microphones and the like. For some additional information concerning the use of multiple microphones to perform acoustic beamforming, reference is made to commonly-owned, co-pending U.S. patent application Ser. No. 12/910,188 to Elias Nemer, entitled “Audio Spatialization for Conference Calls with Multiple and Moving Talkers” and filed Oct. 22, 2010, the entirety of which was incorporated by reference herein. A variety of other references concerning acoustic beamforming are readily available to persons skilled in the art.

FIG. 7 depicts a flowchart 700 of a multi-microphone method for suppressing breathing noise in accordance with an embodiment. The method of flowchart 700 represents a particular manner of performing the method of flowchart 500 as previously described. Like the method of flowchart 500, the method of flowchart 700 may be performed by breathing noise suppressor 126 of telephony device 100 as described above in reference to FIG. 1. However, the method is not limited to that implementation and may be performed by other components or devices.

As shown in FIG. 7, the method of flowchart 700 begins at step 702, in which a time domain representation of a first audio signal produced at least in part by a first microphone (e.g., first microphone 102) and a time domain representation of a second audio signal produced at least in part by a second microphone (e.g., second microphone 108) are received.

At step 704, the time domain representations of the first audio signal and the second audio signal are converted into frequency domain representations. In one embodiment, this step is carried out by applying a Fast Fourier Transform (FFT) to the first and second audio signals. However, this example is not intended to be limiting, and other techniques may be used to convert the time domain representations of the first audio signal and the second audio signal into frequency domain representations. For example, a sub-band analysis may be applied to the time domain representations of the first audio signal and the second audio signal to obtain the frequency domain representations.

At step 706, instantaneous statistics are obtained for each of a plurality of frequency sub-bands based on individual and joint analyses of the frequency domain representations of the first audio signal and the second audio signal. In one embodiment, this step comprises determining the instantaneous power spectrum of the first audio signal (i.e., the instantaneous power in each frequency sub-band for the first audio signal, |Y₁|²), the instantaneous power spectrum of the second audio signal (i.e., the instantaneous power in each frequency sub-band for the second audio signal, |Y₂|²), and the instantaneous cross-spectrum between the first audio signal and the second audio signal (i.e., the cross-product between the first audio signal and the second audio signal for each frequency sub-band, Y₁(f)Y₂*(f)).

At step 708, microphone levels are determined for each of the first and second microphones. For example, the microphone level for the first microphone may be determined by taking the maximum of (a) the sum of the instantaneous power across all frequency sub-bands of the first audio signal as determined during step 706 or (b) a predefined minimum microphone level. The microphone level for the second microphone may be determined in an analogous manner using the instantaneous statistics associated with the second audio signal. However, this is only an example and other methods may be used to determine the microphone levels for each of the first and second microphones.

At step 710, a difference is determined between the microphone level of the first microphone and the microphone level of the second microphone and the difference is mapped to an update rate for noise statistics that will be used in step 714, to be described below. Generally speaking, if the difference between the microphone levels is great, then the user is likely speaking and/or generating breathing noise. In this case, the update rate for noise statistics is set to be low (i.e., no update occurs or updating occurs slowly). Alternatively, if the difference between the microphone levels is small, then the user is likely silent and both microphones are capturing the same acoustic background noise. In this case, the update rate for noise statistics is set to be high. In one embodiment, the difference between the microphone level of the first microphone and the second microphone is mapped to a “forgetting factor” between 1 (which results in no update) and some minimum value (which results in the fastest update). It is noted that in a further embodiment, a difference between microphone levels may be determined for each frequency sub-band, and then a different update rate for noise statistics can be determined and used for each frequency sub-band.

At step 712, the frequency sub-bands in which breathing noise is present are determined based at least one the instantaneous statistics obtained during step 706, the microphone levels determined during step 708, and various information derived therefrom. A particular method for performing step 712 will be described below in reference to flowchart 800 of FIG. 8.

At step 714, noise statistics are updated that will subsequently be used to calculate an estimate of a channel from the second microphone to the first microphone for noise. Such noise statistics are updated in accordance with the update rate that was determined in step 710. In one embodiment, these noise statistics include an estimate of the power spectrum of background noise on the second microphone and an estimate of the cross-spectrum of background noise on both the first and second microphones. In an embodiment in which the update rate is represented as a “forgetting factor” (see description of step 710 above), these noise statistics may be calculated as follows:

Rs2s2(f)=a*Rs2s2(f)+(1−α)*Ry2(f) (Eq. 1)

Rs1s2(f)=a*Rs1s2(f)+(1−α)*Ry1y2(f) (Eq. 2)

wherein α represents the forgetting factor, Ry2(f) represents the instantaneous power spectrum of the second audio signal (a real value), Ry1y2(f) represents the instantaneous cross-spectrum between the first audio signal and the second audio signal (a complex value), Rs2s2(f) represents the estimated power spectrum of background noise on the second microphone, and Rs1s2(f) represents the estimated cross-spectrum of the background noise between the first and second microphones. This calculation is carried out for each frequency sub-band. Of course, this is only an example, and other methods may be used to update the noise statistics. In the previously-described embodiment in which a comfort noise generator is used to generate a replacement audio signal when the first audio signal is determined to include breathing noise, the noise statistics updated during this step may be used as input to the comfort noise generator and used thereby to simulate the background noise of the environment in which the user is located.

At step 716, signal components of the frequency sub-bands of the first audio signal that are determined to include breathing noise are replaced with signal components of the corresponding frequency sub-bands of the second audio signal multiplied by an estimate of the channel from the second microphone to the first microphone for noise. By replacing only those components of the first audio signal that are located in frequency sub-bands determined to include breathing noise with estimated replacement components derived from the second audio signal, this step can eliminate breathing noise from the first audio signal in a manner that will only minimally distort the first audio signal and thus will not be detectable to far end listeners. For example, this step can enable breathing noise to be eliminated from the first audio signal in a manner that essentially preserves acoustic background noise present in the first audio signal.

In an embodiment in which noise statistics are obtained in accordance with Equations (1) and (2) above, the estimate of the channel from the second microphone to the first microphone for noise may be calculated in accordance with:

Wbns(f)=Rs1s2(f)/Rs2s2(f) (Eq. 3)

wherein Wbns(f) is the estimate of the channel from the second microphone to the first microphone for noise, Rs1s2(f) represents the estimated cross-spectrum of the background noise on both the first and second microphones, and Rs2s2(f) represents the estimated power spectrum of background noise on the second microphone. This calculation is carried out for each frequency sub-band in which breathing noise was detected. In further accordance with such an embodiment, the replacement signal component for each frequency sub-band in which breathing noise was detected in the first audio signal is obtained by multiplying the signal component from the corresponding frequency sub-band of the second audio signal by Wbns(f) for that frequency sub-band.

At step 718, the potentially-modified frequency domain representation of the first audio signal obtained from step 716 is converted to a corresponding time domain representation. In one embodiment, this step is achieved by applying an inverse FFT to the potentially-modified frequency domain representation of the first audio signal obtained from step 716. However, this example is not intended to be limiting, and other techniques may be used to convert the potentially-modified frequency domain representation of the first audio signal into a time domain representation. For example, a sub-band synthesis may be applied to the potentially-modified frequency domain representation of the first audio signal. The time domain representation may then be encoded for transmission to one or more remote telephony devices.

It is noted that in alternate embodiments, it is possible that the potentially-modified frequency domain representation of the first audio signal may undergo additional processing before being converted into the time domain.

FIG. 8 depicts a flowchart 800 of a particular method for performing step 712 of flowchart 700, which involves identifying frequency sub-bands in which breathing noise is present in the first audio signal. It is to be understood that step 712 may be performed using other techniques than those that will be described below in reference to flowchart 800 of FIG. 8. Thus, the method of flowchart 800 is described herein by way of example only and is not intended to be limiting.

As shown in FIG. 8, the method of flowchart 800 begins at step 802, in which average statistics are calculated for each frequency sub-band based on the instantaneous statistics obtained during step 706 of flowchart 700. In one embodiment, the average statistics include an average power spectrum of the first audio signal, an average power spectrum of the second audio signal, and an average cross-spectrum between the first audio signal and the second audio signal.

At step 804, a noise level for the first microphone is updated based on the microphone levels obtained during step 708, wherein the update rate used to update the noise level is determined based on a difference between the microphone level of the first microphone and the microphone level of the second microphone. In accordance with an embodiment, the update rate is set to be low (i.e., no update occurs or updating occurs slowly) if the difference between the microphone levels is great (in which case the user is likely speaking and/or generating breathing noise) and is set to be high if the difference between the microphone levels is small (in which case the user is likely silent and both microphones are capturing the same acoustic background noise).

At step 806, an acoustic noise floor of the first microphone is determined on a frequency sub-band basis based on the updated noise level obtained during step 804.

At step 808, a measure of coherence is calculated between the first audio signal and the second audio signal on a frequency sub-band basis based on the average statistics calculated during step 802. In one embodiment, calculating the measure of coherence comprises dividing a squared amplitude of the average cross spectrum of the first audio signal and the second audio signal by the product of the average power spectrum of the first audio signal and the average power spectrum of the second audio signal.

At step 810, a series of contiguous frequency sub-bands beginning below a predefined frequency having a measure of coherence that is less than a predefined threshold is identified.

At step 812, frequency sub-bands of the first audio signal are identified that include breathing noise based on one or more of: (1) the measure of coherence for each sub-band (e.g., if the measure of coherence for a particular frequency sub-band is below a predetermined threshold, this may indicate that the particular frequency sub-band includes breathing noise); (2) whether the power of the first audio signal in a frequency sub-band exceeds an estimated power of the acoustic noise floor of the first microphone in that frequency sub-band (which suggests that breathing noise is present); and (3) whether a particular frequency sub-band is part of any contiguous series identified in step 810.

Although the previously-described methods refer to first and second microphones that produce first and second audio signals, it will be understood by persons skilled in the relevant art(s) that the foregoing techniques may also be implemented using more than two microphones. For example, additional microphones may be used to make additional coherency measurements, estimate noise statistics and noise floors, and to perform signal substitution in instances where breathing noise is detected.

### C. Example Single Microphone Breathing Noise Suppression Systems and Methods

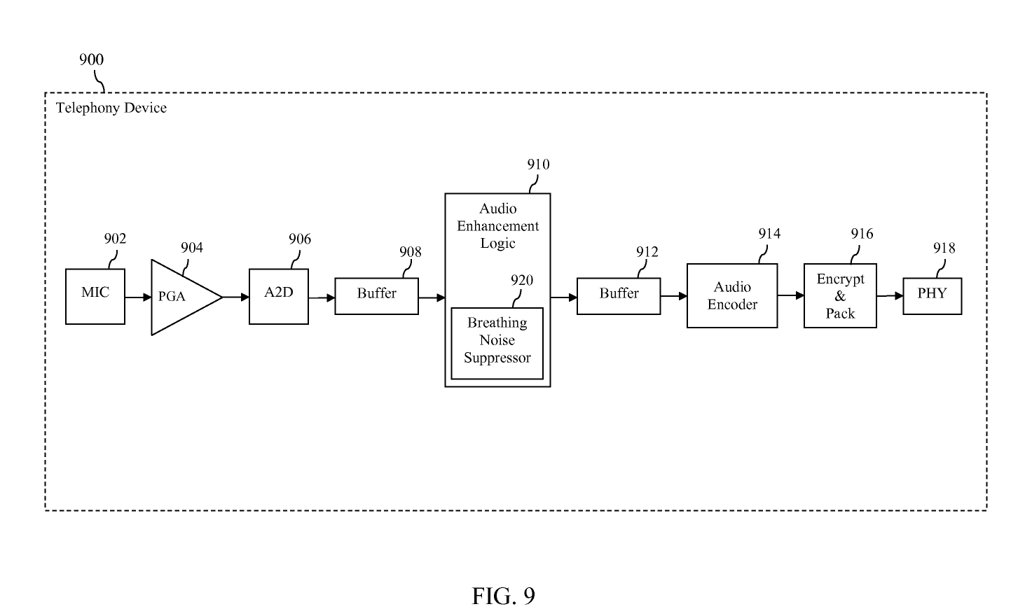

FIG. 9 is a block diagram of an example telephony device 900 that implements a single microphone breathing noise suppression technique in accordance with an embodiment. Telephony device 900 is intended to broadly represent any type of telephony device that is capable of receiving a single input audio signal via a single corresponding microphone and to use such input audio signal to generate an output audio signal for transmission to at least one remote telephony device. The elements of example audio terminal 900 will now be described in more detail.

As shown in FIG. 9, audio terminal 900 includes a microphone 902. Microphone 902 is an acoustic-to-electric transducer that operates in a well-known manner to convert sound waves, such as sound waves associated with a user's speech and/or acoustic noise, into an analog audio signal. A PGA 904 is connected to microphone 902 and is configured to amplify the analog audio signal produced by microphone 902 to generate a first amplified analog audio signal. An A2D converter 906 is connected to PGA 904 and is adapted to convert the amplified analog audio signal produced by PGA 904 into a digital audio signal. The digital audio signal produced by A2D converter 906, or at least a portion thereof, may be temporarily stored in a buffer 908 pending processing by audio enhancement logic 910.

Audio enhancement logic 910 is configured to process the digital audio signal to produce an output digital audio signal. Such output digital audio signal, or at least a portion thereof, may be temporarily stored in a buffer 912 pending processing by an audio encoder 914. Audio enhancement logic 910 may be configured to perform operations that tend to improve the perceptual quality and intelligibility of any speech content included in the output digital audio signal. For example, audio enhancement logic 910 may include a noise suppressor and/or an echo canceller that may operate to improve the perceptual quality and intelligibility of any speech content included in the output digital audio signal.

As further shown in FIG. 9, audio enhancement logic 910 also includes a breathing noise suppressor 920. As will be discussed in more detail herein, breathing noise suppressor 920 operates to determine when breathing noise is present in the digital audio signal that originated from microphone 902 by performing a combination of tests, wherein performing each test includes comparing one or more time and/or frequency characteristics of the digital audio signal to one or more time and/or frequency characteristics of breathing noise. Furthermore, when breathing noise suppressor 920 determines that breathing noise is present in the digital audio signal, it modifies the digital audio signal to suppress the breathing noise therein. As will be discussed below, such modification may include but is not limited to muting the digital audio signal, replacing at least a portion of the digital audio signal with an audio signal generated by a comfort noise generator, or filtering the audio signal to eliminate or at least attenuate the breathing noise. The potentially-modified digital audio signal may then be used to produce the digital output audio signal. Alternatively, the potentially-modified digital audio signal may be further processed to produce the digital output audio signal.

Audio encoder 914 is connected to buffer 912. Audio encoder 914 is configured to receive the output digital audio signal and to compress the output digital audio signal in accordance with a particular encoding technique. Encryption and packing logic 916 is connected to audio encoder 914 and is configured to encrypt and pack the encoded audio signal produced by audio encoder 914 into packets. The packets produced by encryption and packing logic 916 are provided to a physical layer (PHY) interface 918 for subsequent transmission to a remote telephony device over a suitable communication link.

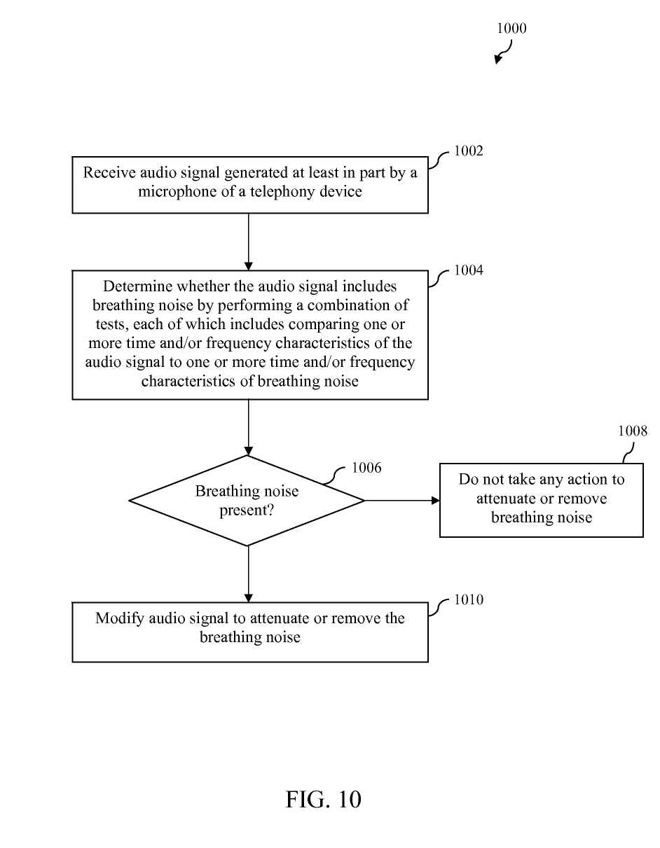

FIG. 10 depicts a flowchart 1000 of a single microphone method for suppressing breathing noise in an audio signal in accordance with an embodiment. The method of flowchart 1000 may be performed by breathing noise suppressor 920 of telephony device 900 as described above in reference to FIG. 9. However, the method is not limited to that implementation and may be performed by other components or devices.

As shown in FIG. 10, the method of flowchart 1000 begins at step 1002, in which an audio signal generated at least in part by a microphone of a telephony device is received. The audio signal may comprise, for example, the digital audio signal that is generated in part by microphone 902 of telephony device 900 as described above in reference to FIG. 9.

At step 1004, it is determined if breathing noise is present in the audio signal. This step is carried out by performing a combination of tests, wherein the performance of each test includes comparing one or more time and/or frequency characteristics of the audio signal to one or more time and/or frequency characteristics of breathing noise. Various examples of the tests that may be performed will be described below in Section C.1.

At decision step 1006, the results of step 1004 are analyzed to determine if breathing noise is present in the audio signal. If it is determined that there is no breathing noise present in the audio signal, then controls flow to step 1008, in which no action is taken to suppress or remove breathing noise in the audio signal. However, if it is determined that there is breathing noise present in the audio signal, then control flows to step 1010, in which the audio signal is modified to attenuate or remove the breathing noise. The manner in which the breathing noise present in the audio signal is attenuated or removed may vary depending upon the implementation. A variety of example approaches will be described below in Section C.2.

1. Example Tests for Detecting Breathing Noise

Various example tests that may be applied during step 1004 to detect breathing noise in an audio signal will now be described. Depending upon the implementation, any or all of these tests, including any sub-combination thereof, may be used to determine whether breathing noise is present in an audio signal.

For example, in accordance with certain embodiments, a combination or sub-combination of the following tests is applied and a result is generated for each applied test, wherein the result either indicates that breathing noise is likely to be present in the audio signal or is not likely to be present in the audio signal. Each result may be represented, for example, using a binary value. For example, a “1” may indicate that breathing noise is likely to be present in the audio signal and a “0” may indicate that breathing noise is not likely to be present in the audio signal, or vice versa. In any case, such test results may be received and processed by a results processor (e.g., logic within breathing noise suppressor 920) to produce a final breathing noise determination for the audio signal. In accordance with such an approach, the results of certain tests may be attributed greater or lesser weight in generating the final breathing noise determination than the results of certain other tests. Whether a test is utilized and what weight is attributed to the result thereof may be determined by a developer of breathing noise suppressor 120. Whether a test is utilized and what weight is attributed to the result thereof may also be controlled using one or more configurable parameters that can be exposed to a manufacturer or distributor of telephone device 900 via a suitable interface.

It is noted that the various example tests described below are not intended to represent an exhaustive list of the various tests that may be applied to determine whether an audio signal includes breathing noise. It is possible that additional tests not described herein may also be used instead of or in addition to any of the tests described below to detect breathing noise.

a. Characteristics of the Poles and Residual Error of a Linear Predictive Coding Analysis

In one embodiment, step 1004 includes performing a linear predictive coding (LPC) analysis on the audio signal received during step 1002 in the time domain and then analyzing the poles and residual error of the LPC analysis to determine whether the audio signal includes breathing noise.

Given that the energy of breathing noise is typically concentrated in the lower frequencies, the spectral envelope derived from an LPC analysis of an audio signal that contains only breathing noise would be expected to contain only a single “formant,” or resonance, in the lower portion of the frequency spectrum. Since there is only a single formant, the results of a low-order LPC analysis (such as a 2nd-order LPC analysis) will yield essentially the same resonance as higher-order LPC analyses (such as 4th- and 10th-order LPC analyses).

In contrast, if the audio signal includes voiced speech, then the audio signal will typically have multiple formants. In this case, it is to be expected that the results of different order LPC analyses (e.g., 2nd-, 4th- and 10th-order LPC analyses) will yield different resonant frequencies, respectively.

Given the spectral distribution of the breathing noise energy, an LPC analysis of a low-order (e.g., 2) may be sufficient to make the necessary determination and should yield a small prediction error for an audio signal that includes only breathing noise, but not so for an audio signal that includes speech, since the latter contains multiple resonances as discussed above. The normalized mean squared prediction error may be derived, for example, from the reflection coefficients in accordance with:

$$P E = {\prod }_{k = 1}^{K} ( 1 - {rc}_{k}^{2} ) , \qquad ( Eq . 4 )$$

wherein PE represents the prediction error, rcₖ represents the reflection coefficients and K is the prediction order. As will be appreciated by persons skilled in the relevant art(s), other means or methods for expressing the normalized mean squared prediction error may be used. Furthermore, other means for measuring the accuracy of the prediction may be used beyond the normalized mean squared prediction error described above.

Furthermore, since LPC analyses of all orders yield essentially the same solutions for an audio signal that includes breathing noise, then evaluating the higher-order LPC polynomials (for example, the 4th and 10th order LPC polynomials) using the roots of a lower-order LPC polynomial (for example, the 2nd order polynomial) should yield a near-zero result.

Accordingly, at least the following detection criteria derived from performing an LPC analysis may be used to determine whether an audio signal comprises breathing noise as opposed to speech in accordance with various implementations: (1) the size of the normalized mean squared prediction error (as defined above) of the LPC analysis of a low order (for example, a 2nd-order LPC analysis); (2) the location of the pole of an LPC analysis of a low order (for example, a 2nd-order LPC analysis); (3) the relation between the roots of the polynomials of LPC analyses of various orders (for example, 2nd-, 4th- and 10th-order LPC analyses); and (4) the resulting error from evaluating an order-M LPC polynomial at the roots of an order-N polynomial (for example, evaluating the order 10 LPC polynomial at the roots of the order 4 LPC polynomial would ideally yield a zero result in the case of an audio signal that includes breathing noise). The former two detection criteria are premised on the fact that the spectral envelope of breathing noise should show a single formant or resonance in the lower part of the frequency spectrum while the latter two detection criteria are premised on the fact that, for breathing noise, an LPC analyses of various orders should all yield essentially the same single resonance.

b. Time Domain Measure of Periodicity

In a further embodiment, step 1004 includes calculating a time-domain measure of periodicity to determine whether the audio signal is periodic or non-periodic. This provides an added metric for distinguishing between breathing noise, which is generally non-periodic in nature, and (voiced) speech, which is generally periodic in nature.

Pitch prediction is used in speech coders to provide an open- or closed-loop estimate of the pitch. A pitch predictor may derive a value that minimizes a mean square error, being the difference between the predicted and actual speech sample. A first order pitch predictor is based on estimating the speech sample in the current period using the sample in the previous one. The prediction error may be represented as:

e[n]=x[n]−g·x[n−L], (Eq. 5)

wherein L is a plausible estimate of the pitch period and g is the pitch gain, or pitch tap. It can be shown that the optimum pitch tap is given by

$$g = \frac{{R}_{x} [ 0 , L ]}{{R}_{x} [ L , L ]} . \qquad ( Eq . 6 )$$

and the optimum pitch period is the one that maximizes the so-called gain ratio:

$${L}_{0} = {max}_{L} \frac{{{R}_{x} [ 0 , L ]}^{2}}{{R}_{x} [ L , L ]} , \qquad ( Eq . 7 )$$

where Rₓ is the autocorrelation of the signal.

Given the periodic nature of voiced speech and the impulsive nature of breathing noise, the maximum gain ratio (defined as the value of the gain ratio for L=L₀, and shown in the equation below) would be expected to be small during breathing noise and generally large during voiced speech segments. Thus, in accordance with one implementation, the audio signal is classified as non-periodic if

$$\frac{{{R}_{x} [ 0 , {L}_{0} ]}^{2}}{{R}_{x} [ {L}_{0} , {L}_{0} ]} < {T}_{3} \qquad ( Eq . 8 )$$

wherein L₀ is the optimum pitch, the left side of the equation represents the maximum gain ratio, and T₃ is a predefined threshold, wherein the predefined threshold may fixed or adaptively determined. As will be appreciated by persons skilled in the relevant art(s), the maximum gain ratio represents only one way of measuring the periodicity of the input audio signal and other measures may be used.

c. Least Square Fit to a Negative Sloping Line

Because breathing noise is expected to have a spectral envelope that decays in a roughly linear fashion (for example, see FIG. 6), step 1004 may comprise obtaining a frequency domain representation of the audio signal received during step 1002 and fitting the energy levels for the frequency sub-bands of such frequency domain representation of the audio signal to a line of the form

y=a·x+b (Eq. 9)

where a is the slope. As will be appreciated by persons skilled in the relevant art(s), using a least squares analysis, an estimate of the slope a, which may be denoted â, may be obtained by solving the normal equations

â=[X^{T}X]⁻¹X^{T}y (Eq. 10)

where the matrix X is an apriori known constant, y is a vector corresponding to the energy values for the frequency sub-bands starting with the lowest frequency sub-band and progressing to the highest, and x represents the frequency values or indices. Based on the least squares analysis, both the estimate of the slope â and the least squares fit error can be obtained.

For breathing noise, it is to be expected that the least squares fit error will be small. Accordingly, in one embodiment, the presence of breathing noise is indicated only if the least squares fit error is less than a predefined threshold. In one example embodiment, the predefined threshold is somewhere in the range of 5-10%. Also, for breathing noise, it is to be expected that the estimated slope obtained through the least squares analysis will be negative. Accordingly, in one embodiment, the presence of breathing noise is indicated if the estimated slope is negative.

d. Difference in Energy Level Between First and Last Strong Sub-Band

In one embodiment, step 1004 comprises obtaining a signal-to-noise ratio (SNR) for each frequency sub-band of a frequency domain representation of the audio signal and identifying a frequency sub-band as a strong sub-band if the SNR for that frequency sub-band exceeds a threshold. In one example embodiment, the threshold is in the range of 8-10 dB. Using this information, and starting with the lowest frequency sub-band and proceeding in order to the highest frequency sub-band, a first strong frequency sub-band may be identified and a lost strong frequency sub-band may be identified. Energy levels associated with the first and last strong frequency sub-bands are also identified and a difference is calculated between them.

For breathing noise, it is to be expected that the energy level between the first strong frequency sub-band and the last strong frequency sub-band will drop at a rate within the range of 5-15 dB per sub-band or faster. Accordingly, in one embodiment, breathing noise is indicated by this test only if the difference in energy level between the first strong frequency sub-band and the last strong frequency sub-band is at least 5 dB per sub-band.

e. Spectrum with Monotonically Decreasing Slope

As noted above, in an embodiment, step 1004 may include determining a first strong frequency sub-band and a last strong frequency sub-band of a frequency domain representation of the audio signal based on SNR. In further accordance with such an embodiment, energy levels may be obtained for the first strong frequency sub-band, the last strong frequency sub-band and every frequency sub-band in between. An absolute energy level difference between each pair of consecutive frequency sub-bands in a range beginning with the first strong frequency sub-band and ending with the last strong frequency sub-band may then be calculated and the absolute energy level differences can be summed. Also, an energy level difference between the first strong frequency sub-band and the last strong frequency sub-band can be calculated.

It is to be expected that the spectral energy shape of breathing noise will be monotonically decreasing. If the spectral energy shape is monotonically decreasing, then the energy level difference between the first strong frequency sub-band and the last strong frequency sub-band should be greater than zero. Furthermore, if the spectral energy shape is monotonically decreasing, then the sum of the absolute energy level differences should be close to the energy level difference between the first strong frequency sub-band and the last strong frequency sub-band. Accordingly, in one embodiment, breathing noise is indicated (1) the energy level difference between the first strong frequency sub-band and the last strong frequency sub-band is greater than zero and (2) the sum of the absolute energy level differences is greater than one-half the energy level difference between the first strong frequency sub-band and the last strong frequency sub-band and less than two times the energy level difference between the first strong frequency sub-band and the last strong frequency sub-band.

f. Detection of Non-Stationarity

In accordance with one embodiment, performing step 1004 comprises determining a measure of energy stationarity to distinguish between an audio signal containing breathing noise and an audio signal containing stationary background noise Background noise tends to vary slowly over time and, as a result, the energy contour changes slowly. This is in contrast to breathing noise and also speech signals, which vary rapidly and thus their energy contours change more rapidly.

In one implementation, the stationarity measure may be made of two parts: the energy derivative and the energy deviation. The energy derivative may be defined as the normalized difference in energy between two consecutive frames of an audio signal and may be expressed as:

$${D}_{a} = \frac{\vert {E}_{f} - {E}_{f - 1} \vert}{{E}_{f}} , \qquad ( Eq . 11 )$$

wherein E_{f} represents the energy of frame f. The energy deviation may be defined as the normalized difference in energy between the energy of the current frame and the long term energy, which can be the smoothed combined energy of the past frames. The energy deviation may be expressed as:

$${D}_{b} = \frac{\vert L T E - {E}_{f} \vert}{L T E} , \qquad ( Eq . 12 )$$

wherein LTE represents the long term energy.

In one embodiment, breathing noise is indicated if a frame of the audio signal is classified as non-stationary. In one particular implementation, a frame of the audio signal is classified as non-stationary if the energy derivative exceeds a first predefined threshold T₁ and the energy deviation exceeds a second predefined threshold T₂. However, this is only an example and other expressions for the derivative and deviation may be used.

2. Example Approaches to Attenuating or Removing Breathing Noise for Single-Microphone Breathing Noise Suppression

As discussed above in reference to flowchart 1000 of FIG. 10, if it is determined that there is breathing noise present in the audio signal received during step 1002, then control flows to step 1010, in which the audio signal is modified to attenuate or remove the breathing noise.

In one embodiment, modifying the audio signal to attenuate or remove the breathing noise comprises simply muting the audio signal. If the detection scheme is reasonably successful at identifying audio signal segments that comprise breathing noise only, muting the audio signal may be deemed an acceptable solution for suppressing the breathing noise.

In another embodiment, modifying the audio signal to attenuate or remove the breathing noise comprises replacing at least a portion of the audio signal with a comfort noise audio signal produced by a comfort noise generator, wherein the comfort noise audio signal simulates the background noise of the environment in which the user is located. A variety of systems and methods for generating comfort noise are known in the art and may be used to perform this function. In accordance with one such system, a Voice Activity Detector (VAD) is used to signal periods of non-speech. This VAD, combined with the breathing noise detector, is then used to isolate periods in the speech utterance where only background noise is present, and to keep track of the background noise statistics in all frequency bands. These statistics will then be input to a comfort noise generator to synthesize a signal whose spectrum resembles that of the background noise, in the frequencies where breathing noise is to be replaced.

In a further embodiment, a filter may be applied to the audio signal to eliminate or at least attenuate the breathing noise while still preserving other components of the audio signal. In one embodiment, the filter may comprise a fixed filter having characteristics suitable for suppressing breathing noise. For example, since breathing noise has a large concentration of energy in the lower spectrum with little or no energy in the upper spectrum (as shown by FIG. 6), a high pass or notch filter having a fixed set of filter parameters may be applied to eliminate or at least attenuate breathing noise.

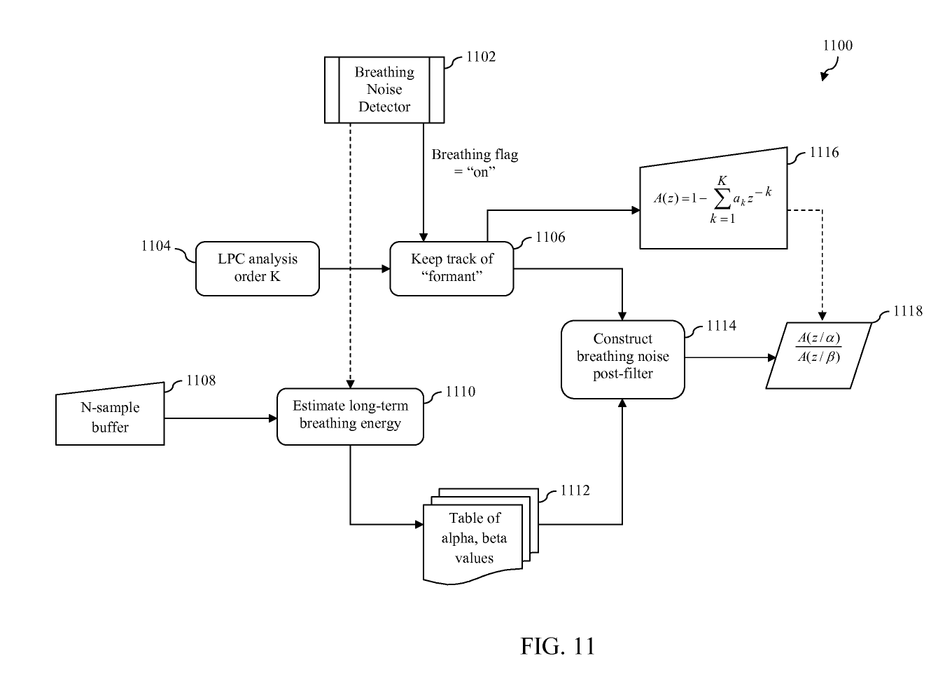

In another embodiment, an adaptive filter may be applied to eliminate or at least attenuate the breathing noise. By way of example, FIG. 11 is a block diagram of a system 1100 that adaptively constructs a notch filter that can be applied to suppress breathing noise in an audio signal. As shown in FIG. 11, system 1100 includes a breathing noise detector 1102 that operates to determine when an input audio signal includes breathing noise. When breathing noise detector 1102 determines that the input audio signal includes breathing noise, it sets a breathing flag into an “on” state. This causes several other logic blocks of system 1100 to perform certain functions necessary for constructing a breathing noise post-filter. These other functions will now be described.

A logic block 1104 performs an LPC analysis of order K on the input audio signal when breathing noise is detected. This LPC analysis enables a logic block 1106 to keep track of the frequency location of the formant of the spectral envelope of the breathing noise. Such location may then be used in logic block 1116 to determine the expression A(z) where:

$$A ( z ) = {\sum }_{k = 1}^{K} {a}_{k} {z}^{- k} \qquad ( Eq . 13 )$$

where K is the desired filter order and aₖ are coefficients that are determined based on the frequency location of the formant.

As further shown in FIG. 11, a logic block 1110 analyzes samples of the input audio signal that are obtained from an N-sample buffer 1108 to estimate a long-term breathing energy. This estimated long-term breathing energy can then be used to select an appropriate α and β value from a table 1112 of such values. The selected α and β values are then provided to a logic block 1114 that also utilizes the expression A(z) provided by logic block 1116 to construct an adaptive notch filter of the form:

$$\frac{A ( z / α )}{B ( z / β )} \qquad ( Eq . 14 )$$

where the range of values of α and β in the tables can be determined a priori in order to achieve a desired level of attenuation for different levels of estimated breathing noise energies. Of course, this method of adaptive filter construction is provided herein by way of example only and is not intended to be limiting. A variety of other methods may be used to adaptively derive a suitable filter for performing breathing noise suppression.

### D. Example Computer System Implementation

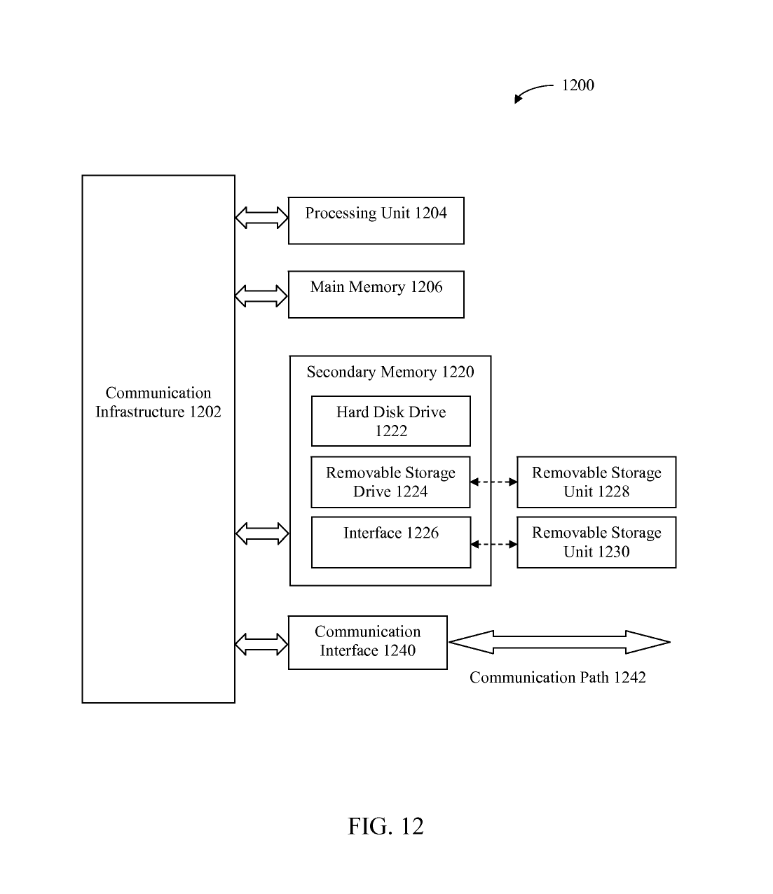

Certain elements of the various systems depicted in FIGS. 1, 9 and 11 and each of the steps of flowcharts depicted in FIGS. 5, 7, 8 and 10 may be implemented by one or more processor-based computer systems. An example of such a computer system 1200 is depicted in FIG. 12.

As shown in FIG. 12, computer system 1200 includes a processing unit 1204 that includes one or more processors. Processor unit 1204 is connected to a communication infrastructure 1202, which may comprise, for example, a bus or a network.

Computer system 1200 also includes a main memory 1206, preferably random access memory (RAM), and may also include a secondary memory 1220. Secondary memory 1220 may include, for example, a hard disk drive 1222, a removable storage drive 1224, and/or a memory stick. Removable storage drive 1224 may comprise a floppy disk drive, a magnetic tape drive, an optical disk drive, a flash memory, or the like. Removable storage drive 1224 reads from and/or writes to a removable storage unit 1228 in a well-known manner. Removable storage unit 1228 may comprise a floppy disk, magnetic tape, optical disk, or the like, which is read by and written to by removable storage drive 1224. As will be appreciated by persons skilled in the relevant art(s), removable storage unit 1228 includes a computer usable storage medium having stored therein computer software and/or data.

In alternative implementations, secondary memory 1220 may include other similar means for allowing computer programs or other instructions to be loaded into computer system 1200. Such means may include, for example, a removable storage unit 1230 and an interface 1226. Examples of such means may include a program cartridge and cartridge interface (such as that found in video game devices), a removable memory chip (such as an EPROM, or PROM) and associated socket, and other removable storage units 1230 and interfaces 1226 which allow software and data to be transferred from the removable storage unit 1230 to computer system 1200.

Computer system 1200 may also include a communication interface 1240. Communication interface 1240 allows software and data to be transferred between computer system 1200 and external devices. Examples of communication interface 1240 may include a modem, a network interface (such as an Ethernet card), a communications port, a PCMCIA slot and card, or the like. Software and data transferred via communication interface 1240 are in the form of signals which may be electronic, electromagnetic, optical, or other signals capable of being received by communication interface 1240. These signals are provided to communication interface 1240 via a communication path 1242. Communications path 1242 carries signals and may be implemented using wire or cable, fiber optics, a phone line, a cellular phone link, an RF link and other communications channels.

As used herein, the terms “computer program medium” and “computer readable medium” are used to generally refer to non-transitory media such as removable storage unit 1228, removable storage unit 1230 and a hard disk installed in hard disk drive 1222. Computer program medium and computer readable medium can also refer to non-transitory memories, such as main memory 1206 and secondary memory 1220, which can be semiconductor devices (e.g., DRAMs, etc.). These computer program products are means for providing software to computer system 1200.

Computer programs (also called computer control logic, programming logic, or logic) are stored in main memory 1206 and/or secondary memory 1220. Computer programs may also be received via communication interface 1240. Such computer programs, when executed, enable the computer system 1200 to implement features of the present invention as discussed herein. Accordingly, such computer programs represent controllers of the computer system 1200. Where the invention is implemented using software, the software may be stored in a computer program product and loaded into computer system 1200 using removable storage drive 1224, interface 1226, or communication interface 1240.

The invention is also directed to computer program products comprising software stored on any computer readable medium. Such software, when executed in one or more data processing devices, causes a data processing device(s) to operate as described herein. Embodiments of the present invention employ any computer readable medium, known now or in the future. Examples of computer readable mediums include, but are not limited to, primary storage devices (e.g., any type of random access memory) and secondary storage devices (e.g., hard drives, floppy disks, CD ROMS, zip disks, tapes, magnetic storage devices, optical storage devices, MEMs, nanotechnology-based storage device, etc.).

### E. Conclusion

While various embodiments of the present invention have been described above, it should be understood that they have been presented by way of example only, and not limitation. It will be understood by those skilled in the relevant art(s) that various changes in form and details may be made therein without departing from the spirit and scope of the invention as defined in the appended claims. Accordingly, the breadth and scope of the present invention should not be limited by any of the above-described exemplary embodiments, but should be defined only in accordance with the following claims and their equivalents.

What is claimed is:

1. A method for suppressing breathing noise in an audio signal, comprising:
receiving a first audio signal generated at least in part by a first microphone of a device and a second audio signal generated at least in part by a second microphone of the device, the first microphone being situated more closely to a mouth of a user of the device than the second microphone;
determining when breathing noise is present in the first audio signal by at least jointly analyzing the first audio signal and the second audio signal; and
in response to determining that breathing noise is present in the first audio signal, modifying the first audio signal to attenuate or remove the breathing noise.

2. The method of claim 1, wherein the determining step comprises:
calculating a measure of coherence between the first audio signal and the second audio signal; and
determining that breathing noise is present in the first audio signal based on at least the measure of coherence.

3. The method of claim 2, wherein calculating the measure of coherence between the first audio signal and the second audio signal comprises estimating a cross-correlation between the first audio signal and the second audio signal in a time domain or evaluating a cross-spectrum between the first audio signal and the second audio signal in a frequency domain.

4. The method of claim 2, wherein calculating the measure of coherence between the first audio signal and the second audio signal comprises estimating a fourth-order cross cumulant between the first audio signal and the second audio signal.

5. The method of claim 2, wherein calculating the measure of coherence between the first audio signal and the second audio signal comprises calculating a measure of coherence between a frequency domain representation of the first audio signal and a frequency domain representation of the second audio signal for each of a plurality of frequency sub-bands; and
wherein determining that breathing noise is present in the first audio signal comprises determining that breathing noise is present in a particular frequency sub-band of the frequency domain representation of the first audio signal in response to at least determining that the particular frequency sub-band has a measure of coherence that is less than the predefined threshold.

6. The method of claim 5, wherein calculating the measure of coherence between the frequency domain representation of the first audio signal and the frequency domain representation of the second audio signal for each of the plurality of frequency sub-bands comprises:
dividing a squared amplitude of an average cross spectrum of the frequency domain representation of the first audio signal and the frequency domain representation of the second audio signal by the product of an average power spectrum of the frequency domain representation of the first audio signal and an average power spectrum of the frequency domain representation of the second audio signal.

7. The method of claim 5, wherein determining that breathing noise is present in the particular frequency sub-band of the frequency domain representation of the first audio signal further comprises:
determining that the particular frequency sub-band is one of a contiguous series of frequency sub-bands beginning below a predefined frequency, each of the contiguous series of frequency sub-bands having a measure of coherence that is less than the predefined threshold.

8. The method of claim 5, wherein determining that breathing noise is present in the particular frequency sub-band of the frequency domain representation of the first audio signal further comprises:
determining that a power of the frequency domain representation of the first audio signal in the particular frequency sub-band exceeds an estimated power of a noise floor of the first audio signal at the particular frequency sub-band by at least a predefined amount.

9. The method of claim 1, wherein modifying the first audio signal to suppress or remove the breathing noise comprises replacing at least a portion of the first audio signal with at least a portion of the second audio signal or with an audio signal that is derived from at least a portion of the second audio signal.

10. The method of claim 1, wherein determining that breathing noise is present in the first audio signal comprises determining that breathing noise is present in particular frequency sub-bands of a frequency domain representation of the first audio signal; and
wherein modifying the first audio signal to suppress or remove the breathing noise comprises replacing signal components in the particular frequency sub-bands of the frequency domain representation of the first audio signal with signal components derived from corresponding frequency sub-bands of a frequency domain representation of the second audio signal.

11. The method of claim 10, wherein replacing the signal components in the particular frequency sub-bands of the frequency domain representation of the first audio signal with the signal components derived from the corresponding frequency sub-bands of the frequency domain representation of the second audio signal comprises:
calculating an estimate of a channel from the second microphone to the first microphone for noise for each of the particular frequency sub-bands; and
multiplying the estimate of the channel for each of the particular frequency sub-bands by signal components in the corresponding frequency sub-bands of the frequency domain representation of the second audio signal to obtain replacement signal components for each of the particular frequency sub-bands; and
replacing the signal components in the particular frequency sub-bands of the frequency domain representation of the first audio signal with the replacement signal components for the corresponding frequency sub-bands.

12. The method of claim 11, further comprising updating statistics that are used to calculate the estimate of the channel at a rate that is based on a difference in an energy level calculated for the first microphone and an energy level calculated for the second microphone.

13. The method of claim 1, wherein modifying the first audio signal to suppress or remove the breathing noise comprises muting the first audio signal.

14. The method of claim 1, wherein modifying the first audio signal to suppress or remove the breathing noise comprises replacing at least a portion of the first audio signal with an audio signal generated by a comfort noise generator.

15. The method of claim 1, wherein modifying the first audio signal to suppress or remove the breathing noise comprises utilizing a beamformer to attenuate or remove the breathing noise in the first audio signal.

16. A device, comprising:
a first microphone that generates a first audio signal;
a second microphone that generates a second audio signal, the second microphone being situated such that it will be farther from a mouth of a user of the device during normal usage thereof; and
breathing noise suppression logic that is configured to determine when breathing noise is present in the first audio signal by at least jointly analyzing the first audio signal and the second audio signal and to modify the first audio signal to suppress or remove the breathing noise in response to determining that breathing noise is present therein.

17. A method for suppressing breathing noise in an audio signal, comprising:
determining whether an audio signal includes breathing noise, wherein determining whether the audio signal includes breathing noise comprises performing a combination of tests and wherein performing each test includes comparing one or more time and/or frequency characteristics of the audio signal to one or more time and/or frequency characteristics of breathing noise; and
applying breathing noise suppression to the audio signal if it is determined to include breathing noise.

18. The method of claim 17, wherein comparing one or more time characteristics of the audio signal to one or more time characteristics of breathing noise comprises performing at least one of:
analyzing results associated with a linear predictive coding (LPC) analysis of the audio signal; and
determining if the audio signal is periodic.

19. The method of claim 18, wherein analyzing the results associated with the LPC analysis of the audio signal comprises one or more of:
determining a size of a normalized mean squared prediction error of an LPC analysis of the audio signal;
determining a location of a pole of an LPC analysis of the audio signal;
determining a relation between roots of polynomials of LPC analyses of various orders of the audio signal; and
determining a resulting error from evaluating an order-M LPC polynomial at roots of an order-N LPC polynomial.

20. The method of claim 19, wherein determining the size of the normalized mean squared prediction error of the LPC analysis of the audio signal comprises:
determining the size of a normalized mean squared prediction error of a second order LPC analysis of the audio signal.

21. The method of claim 19, wherein determining the location of the pole of the LPC analysis of the audio signal comprises:
determining a location of a pole of a second order LPC analysis of the audio signal.

22. The method of claim 19, wherein determining the relation between the roots of the polynomials of the LPC analyses of various orders of the audio signals comprises:
determining a relation between roots of polynomials of second order, fourth order and tenth order LPC analyses of the audio signal.

23. The method of claim 19, wherein determining the resulting error from evaluating the order-M LPC polynomial at the roots of the order-N LPC polynomial comprises:
determining a resulting error residual from evaluating a tenth order LPC polynomial at roots of a fourth order LPC polynomial.

24. The method of claim 18, wherein determining if the audio signal is periodic comprises:
calculating a pitch period associated with the audio signal;
calculating a maximum gain ratio based on the pitch period;
determining if the maximum gain ratio is less than a predefined threshold; and
determining that the audio signal is periodic if the maximum gain ratio is not less than the predefined threshold.

25. The method of claim 17, wherein comparing one or more frequency characteristics of the audio signal to one or more frequency characteristics of breathing noise comprises performing at least one of:
performing a least squares analysis to fit a series of frequency sub-band energy levels associated with a frame to a linearly sloping downward line;
calculating an energy difference between frames of the audio signal;
determining if a spectral energy shape associated with the audio signal is monotonically decreasing; and
calculating a difference between an energy level associated with a first strong frequency sub-band associated with a frame and a last strong frequency sub-band associated with the frame.

26. The method of claim 17, wherein applying breathing noise suppression to the audio signal if it is determined to include breathing noise comprises muting the audio signal.

27. The method of claim 17, wherein applying breathing noise suppression to the audio signal if it is determined to include breathing noise comprises replacing at least a portion of the audio signal with a comfort noise audio signal generated by a comfort noise generator.

28. The method of claim 17, wherein applying breathing noise suppression to the audio signal if it is determined to include breathing noise comprises applying a filter to the audio signal.

29. The method of claim 28, wherein applying a filter to the audio signal comprises applying an adaptive notch filter to the audio signal.

30. A device, comprising:
a microphone that generates an audio signal; and
breathing noise suppression logic that is configured to determine when breathing noise is present in the audio signal by performing a combination of tests, wherein performing each test includes comparing one or more time and/or frequency characteristics of the audio signal to one or more time and/or frequency characteristics of breathing noise, and applying breathing noise suppression to the audio signal if it is determined to include breathing noise.
